(19) United States
(12) Patent Application Publication
(10) Pub. No.: US 2014/0156415 A1
(43) Pub. Date: Jun. 5, 2014

(54) TECHNIQUES FOR DETERMINING THE AGE AND GENDER OF A CONSUMER

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/691,631

(22) Filed: Nov. 30, 2012

(51) Int. Cl. G06Q 30/02

(52) U.S. Cl. CPC G06Q 30/0269
USPC 705/14.66

(57) ABSTRACT

A computer-implemented method is disclosed herein. The method includes the step of receiving, at a processing device of a commerce server, at least one of a video signal and an audio signal from a head mountable unit. The method also includes the step of deriving, at the processing device, a demographic value in response to the at least one of the video signal and the audio signal. The demographic value is indicative of at least one of a gender and an age of a user of the head mountable unit. The method also includes the step of obtaining, at processing device, an advertisement in response to the demographic value. The method also includes the step of transmitting the advertisement to the head mountable unit with the processing device of the commerce server.

### BACKGROUND INFORMATION

1. Field of the Disclosure

The present invention relates generally to systems and methods for optimizing the delivery of targeted advertising to consumers. In particular, examples of the present invention are related to techniques for determining the age and gender of a new consumer and thereafter delivering advertising that is determined to be particularly effective in view of the consumer's age and gender.

2. Background

Advertising is the act or practice of calling public attention to one's product or service. Many products and services are suited for a particular demographic, such as a magazine for teenage girls or shaving cream for men. Therefore, advertising can be developed to be particularly effective for a particular age range, for a particular gender, or both. For example, it has been found that men are more likely to enjoy humorous advertising while women are generally more likely to enjoy advertising featuring realistic life situations.

Another consideration in advertising is the likelihood that an advertisement designed for a particular demographic will in fact reach a person of that demographic. In the past, advertising was placed in periodicals that were believed to be of interest to the targeted demographic in a “blanket-type” approach. Current technology such as HTTP cookies and social media history allows advertisers to precisely identify and reach a person in the demographic of interest. However, this historical information may not be available for a consumer at a bricks-and-mortar retail store.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating a system according to one exemplary embodiment of the invention.

FIG. 2 is a block diagram illustrating a head mountable unit that can be applied in some embodiments of the present disclosure.

FIG. 3 is a block diagram illustrating a commerce server that can be applied in some embodiments of the present disclosure.

FIG. 4 is a flow chart illustrating a method that can be carried out according to some embodiments of the present disclosure.

FIG. 5 is a flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. . In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied an any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

It can be desirable to deliver targeted advertisements to a consumer. Advertisements can be targeted in response to the consumer's previous purchase history, age, and/or gender. However, these metrics may not be available for a new consumer. Further, attempting to solicit information can be viewed negatively by the new consumer and can therefore be detrimental to establishing a positive relationship with the new consumer.

Embodiments of the present invention overcome these problems by providing techniques for determining the age and gender of a consumer without soliciting this information directly. For example, a system according to an embodiment of the invention can include a commerce server receiving video and/or audio signals from a head mountable unit worn by the consumer. The head mountable unit can transmit a video signal corresponding to the field of view of the consumer. This image data can be processed and analyzed by the commerce server to estimate the height of the consumer. In addition, the head mountable unit can transmit the consumer's voice as an audio signal to the commerce server. The audio signal can be processed and analyzed by the commerce server to estimate the age and the gender of the consumer. The estimation of height from the video signal can be cross-referenced with the estimation of age and gender to determine a likely age and gender of the consumer. The commerce server can then access a database containing a plurality of a plurality of advertisements stored therein and select one or more of the advertisements. Each advertisement can be associated with one or more demographic values. For example, an advertisement for Teen magazine may be stored in the database as part of a “female” category of advertisements and as part of an “ages 12-16” category of advertisements. Conversely, an advertisement for Maxim magazine may be stored in the database as part of a “male” category of advertisements and as part of an “ages 21-55” category of advertisements. The commerce server can then communicate the selected, targeted advertising to the consumer through the head mountable unit.

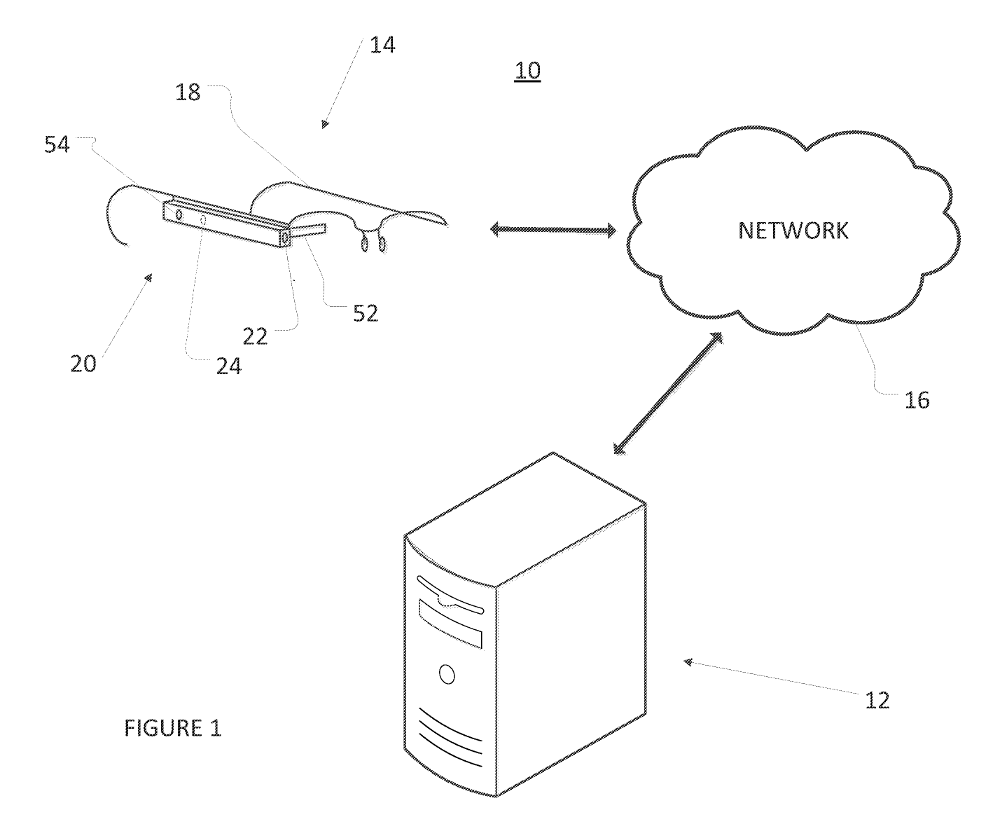

To illustrate, FIG. 1 is a schematic illustrating a system 10 according to some embodiments of the present disclosure. The system 10 can implement a computer-implemented method that includes the step of receiving, at a processing device of a commerce server 12, at least one of a video signal and an audio signal from a head mountable unit 14. The signal from the head mountable unit 14 and received by the commerce server 12 can be transmitted through a network 16. As used herein, the term “network” can include, but is not limited to, a Local Area Network (LAN), a Metropolitan Area Network (MAN), a Wide Area Network (WAN), the Internet, and combinations thereof.

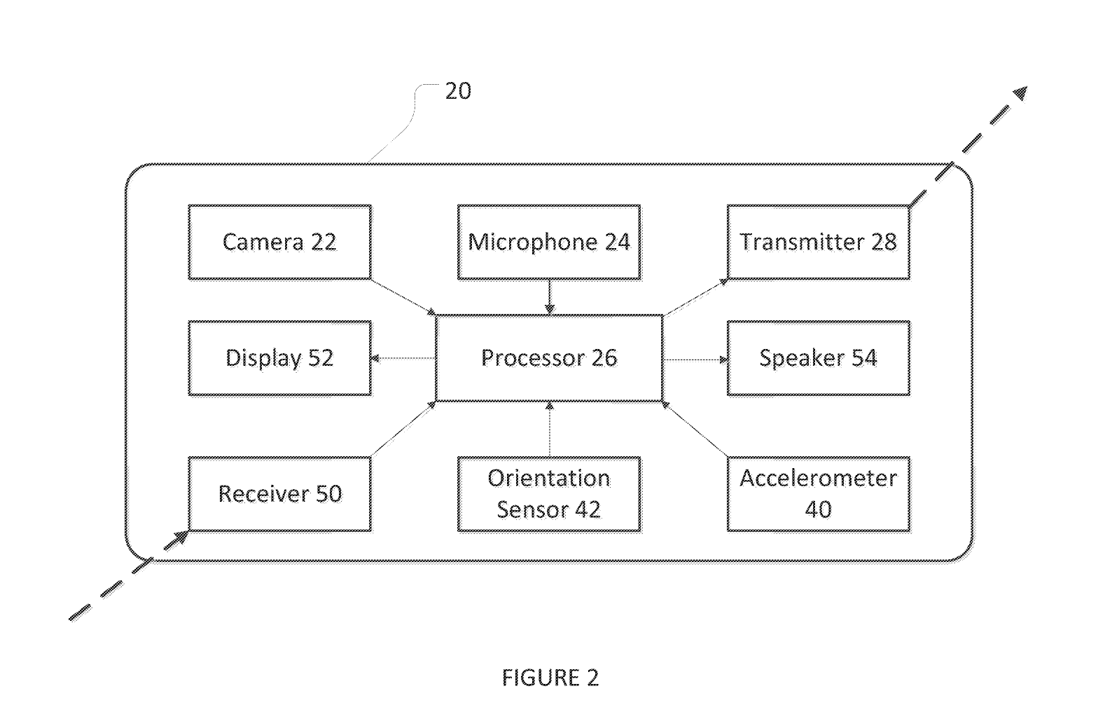

The head mountable unit 14 can be worn by a consumer while moving within a retail store. In the illustrated embodiment of FIG. 1, the exemplary head mountable unit 14 includes a frame 18 and a communications unit 20 supported on the frame 18. FIG. 2 is a block diagram illustrating exemplary components of a communications unit 20. The communications unit 20 can include a camera 22, a microphone 24, a processor 26, a transmitter 28, an accelerometer 40, an orientation sensor 42, a receiver 50, a display 52, and a speaker 54.

The camera 22 is operable to capture single images and/or video and to generate a video signal based thereon. The video signal can correspond to the field of view of the consumer wearing the head mountable unit 14. The microphone 24 (shown in phantom) is operable to capture audio data and generate an audio signal based thereon. The audio signal can correspond to sounds that are proximate to the consumer, including the voice of the consumer wearing the head mountable unit 14.

The processor 26 is operable to receive the video signal from the camera 22 and the audio signal from the microphone 24. While one processor 26 is illustrated, it should be appreciated that the term “processor” can include two or more processors that operate in an individual or distributed manner. The transmitter 28 is in electrical communication with the processor 26. The processor 26 is operable to direct the video and audio signals to the transmitter 28 and the transmitter 28 is operable to transmit the video signal and/or audio signal from the head mountable unit 14, such as to the commerce server 12 through the network 16.

The accelerometer 40 can be a sensor that is operable to detect the motion of the consumer wearing the head mountable unit 14. The accelerometer 40 can generate a signal in response to the movement that is detected and can communicate the signal to the processor 26. The motion that is detected can be the acceleration of the consumer and the processor 26 can derive the velocity of the consumer from the acceleration. The data relating to the consumer's motion can be a variable in an algorithm that derives the consumer's height.

The orientation sensor 42 can be operable to detect the orientation of the head mountable unit 14 and thus also detect the orientation of the consumer's head and field of view. A gyroscope can be a component of the orientation sensor 42. The orientation sensor 42 can generate a signal in response to the orientation that is detected and communicate the signal to the processor 26. The data relating to the orientation of the consumer's head and view can be a trigonometric variable in an algorithm that derives the consumer's height.

The receiver 50 can be operable to receive transmissions from the network and then communicate the transmissions to the processor 26. In some embodiments of the present disclosure, the receiver 50 and the transmitter can be an integral unit.

The display 52 can be positioned within the consumer's field of view. One or more files having video content can be shown to the consumer with the display 52. Each file contains data sent electronically to the customer and can include an advertisement or any other information that might be interesting to the consumer. For example, an advertisement file having video content can be received by the receiver 50 and communicated to the processor 26. The processor 26 can then control the display 52 to show the video content of the advertisement file. The display 52 can be a transparent when not in use to minimize obstruction of the consumer's field of view.

The speaker 54 can be positioned within the consumer's range of hearing. One or more advertisement files having audio content can be played for the consumer through the speaker 54. An advertisement file having audio content can be received by the receiver 50 and communicated to the processor 26. The processor 26 can then control the speaker 54 to emit the audio content of the advertisement file.

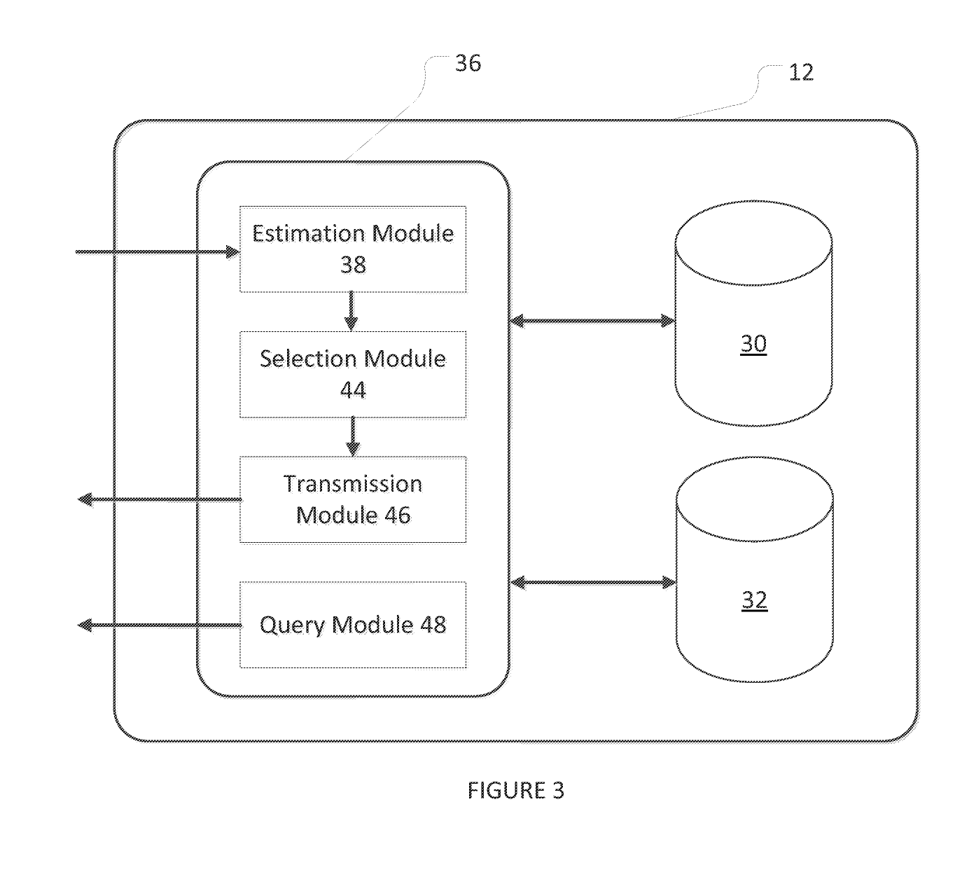

FIG. 3 is a block diagram illustrating a commerce server 12 that can be applied in some embodiments of the present disclosure. In the illustrated embodiment, the commerce server 12 includes processing device 36 and a database 30. The database 30 includes memory containing a plurality of advertisement files, each of the plurality of advertisement files being associated with at least one of an age and a gender. Each of the advertisement files can be assigned to one or more categories, such as a first category of age ranges and second category of gender. Further, the primary categories can be divided into sub-categories and each of the advertisement files can be assigned to one or more sub-categories of each of the primary categories. The advertisement files can be located within the database 30 in response to a table or an algorithm.

The processing device 36 can include computer readable memory storing computer readable instructions and one or more processors executing the computer readable instructions. The exemplary processing device 36 can execute an estimation module 38, a selection module 40, and a transmission module 42.

The estimation module 38 can be configured to receive at least one of the video signal and the audio signal from the head mountable unit 14 and to estimate one or more demographics of a user of the head mountable unit 14 in response to the received signal(s). As used herein, the term “demographic” may include, but is not limited to, gender and age.

In some embodiments, the estimation module 38 can derive the gender of the user in response to the audio signal. For example, the estimation module 38 can analyze the audio signal to identify a speech portion of the audio signal. The speech portion can correspond to a portion of sound, a vocal noise, or one or more words that were spoken by a user of the head mountable unit 14. The estimation module 38 can implement known speech recognition/analysis techniques to determine that the voice conveyed by the audio signal is likely to correspond to a male or a female.

In some embodiments, the estimation module 38 can estimate an age group of the user in response to the audio signal. For example, the estimation module 38 can detect a speech portion of the audio signal and can analyze the speech portion to determine an age group of the user.

In some embodiments, the estimation module 38 can derive multiple demographics of the user in response to the audio signal. For instance, the estimation module 38 can determine the gender of the user and the age of the user in the manners described above.

In some embodiments, the estimation module 38 is configured to analyze a video signal received from the head mountable unit 14. The video signal can correspond to the field of view of the user. The user can be moving within a retail store associated with the commerce server 12. The heights of fixtures and shelves within the retail store, the products within the retail store, and the locations of the products can be stored in a second database 32. This data can be accessed by the estimation module 38 during the analysis of the images in the video signal. For example, in response to the analysis of the video signal, the estimation module 38 can determine one of the products that had been viewed by the consumer. Further, in response to the data in the second database 32, the estimation module 38 can determine the height of the product within the retail store. The height determination can be correlated with the orientation data received from the orientation sensor 42. The height of the product and the orientation of the head mountable unit while the product is being shot by the camera 22 can be applied together in a trigonometric relationship to determine the height of the head mountable unit 14.

The exemplary processing device 36 also includes a selection module 44 operable to receive the value, or values, from the estimation module 38 and obtain one or more of the plurality of advertisement files in the database 30 in response to the value(s). The selection module 44 selects an advertisement file consistent with the one or more values derived by the estimation module 38. If the estimation module 38 has derived a first value for age and second value for gender, the selection model can receive both values and select one or more advertising files from the database 30 that are consistent with both values. The selection module 44 can access the memory addresses in the database 30 containing relevant advertisement files.

The processing device 36 also includes a transmission module 46 operable to electronically transmit the advertisement file selected by the selection module 44 from the commerce server 12, to the head mountable unit 14. The advertisement file that is transmitted to the head mountable unit 14 can be an audio file or some other form of electronic file that includes audio data. The advertisement file that is transmitted to the head mountable unit 14 can be an image file, a video, or any electronic file that includes image data. The advertisement file that is transmitted to the head mountable unit 14 can include both audio data and image data.

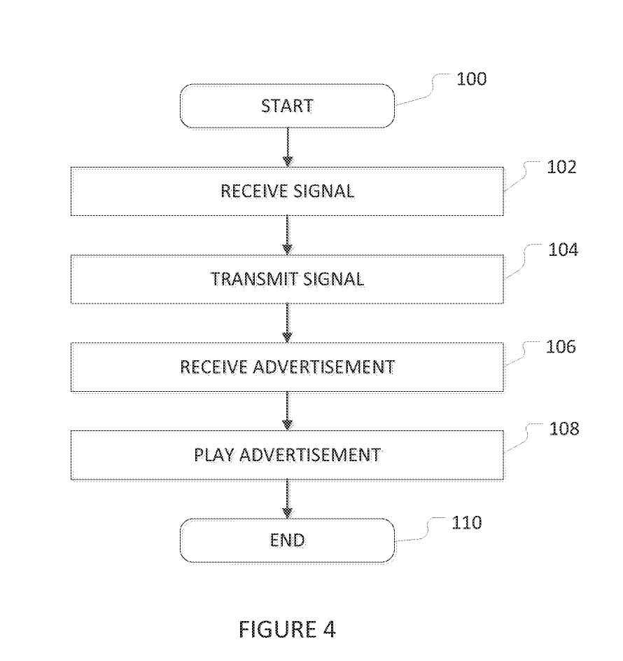

FIG. 4 is a flow chart illustrating a method that can be carried out in some embodiments of the present disclosure. The method can be executed by a processor of a head mountable unit. The method starts at step 100. At step 102, the processor can receive a signal. The signal can be an audio signal or a video signal or a signal that includes both audio and video data. The signal can be any signal that can be at least partially indicative of demographic associated with the wearer of head mountable unit.

At step 104, the processor can transmit the signal. The processor can transmit the signal over a network. The processor can at least partially process the signal or transmit the signal directly. For example, the processor can configured to convert an analog signal to a digital signal prior to transmission or can transmit the analog signal.

At step 106, the processor can receive an advertisement in response to the signal transmitted at step 102. For example, if the signal received at step 102 and transmitted at step 104 tends to indicate that the user of the head mountable unit is female and is a senior citizen, the advertisement received at step 106 can be for a product that tends to be of interest to both women and to senior citizens. Alternatively, the advertisement received can be for a product associated with a broader demographic. For example, if the signal received at step 102 and transmitted at step 104 tends to indicate that the user of the head mountable unit is female and is a senior citizen, the advertisement received at step 106 can be for a product that tends to be of interest to women.

At step 108, the processor can control a display and/or speaker of the head mountable unit to play the advertisement. The advertisement can be an image or a video. The advertisement can be an audio message or can be the combination of audio and video. The exemplary method ends at step 110.

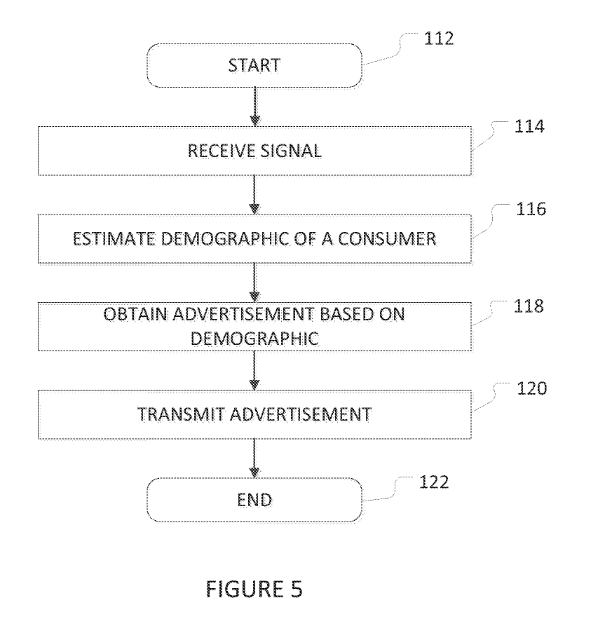

FIG. 5 is a flow chart illustrating a method that can be carried out in some embodiments of the present disclosure. The method can be executed by a commerce server. The commerce server can be located at the retail store or can be remote from the retail store. The method starts at step 112. At step 114, the commerce server can receive a signal. The signal can be an audio signal or a video signal or a signal that includes both audio and video data. The signal is associated with a consumer. The signal can be any signal that can be at least partially indicative of one or more particular demographics.

At step 116, at least one demographic of the user is estimated in response to the signal received at step 114. The demographic can be an age range or a gender. In some embodiments, more than one demographic can be estimated for a single signal, such as an age range and gender.

At step 118, an advertisement can be obtained in response to the one or more estimated demographics. For example, if the signal received at step 114 tends to indicate that the user of the head mountable unit is male, the advertisement obtained at step 118 can be for a product that tends to be of interest to men. At step 120, the advertisement can be transmitted and the exemplary method ends at step 122.

In some embodiments, the consumer can be provided with a head mountable unit 14. Other embodiments could be practiced with a head mountable unit 14 owned or pre-possessed by the consumer. The consumer could enter the retail store with his or her own head mountable unit 14. The commerce unit 12 can be operable to communicate with a head mountable unit 14 owned by the consumer.

In some embodiments, the consumer can be prompted to communicate an audio signal to the commerce server 12. The transmission of the video signal can begin as soon as the consumer puts on the head mountable unit 14. The processing device 36 can include a query module 48 operable to transmit signals to the head mountable unit 14 soliciting an audio signal from the consumer. It can be desirable to receive an audio signal from the consumer for processing without expressly requesting age or gender. The query module 48 can transmit a message with the head mountable unit 14 such as greeting; the consumer's response can be processed to derive age and gender. Alternatively, the query module 48 can deliver a tutorial for using the head mountable unit 14 to the consumer. Such interaction can generate voice responses from the consumer that can be analyzed by the estimation module 38 without the consumer feeling interrogated. If the consumer is talking without being prompted, the query module 48 need not be activated.

In some embodiments of the present disclosure, audio and video data streams can be manipulated on the display 52 of the head mountable unit 14 to reduce required bandwidth. For example, the video signal could be converted from color images to black and white or to indexed color. Similarly, an audio signal can be re-sampled to a low bit rate and only certain data file might be sent. Further, background filtering can be done in some embodiments to reduce the bandwidth of the processor 26 consumed by the advertisement data files. All of this processing could be done by processor 26 of the head mountable unit 14 rather than being executed by the processing device 36 of the commerce server 12.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method comprising:
receiving, at a processing device of a commerce server, at least one of a video signal and an audio signal or derived data from such a video or audio stream from a head mountable unit;
deriving, at the processing device, a demographic value in response to the at least one of the video signal and the audio signal, the demographic value being indicative of at least one of a gender and an age of a user of the head mountable unit;
obtaining, at processing device, an advertisement in response to the demographic value; and
transmitting the advertisement to the head mountable unit with the processing device of the commerce server.

2. The computer-implemented method of claim 1 wherein deriving step is further includes:
deriving a gender value being indicative for a gender of a consumer wearing the head mountable unit.

3. The computer-implemented method of claim 1 wherein said deriving step is further defined as:
deriving a value for an age associated with the audio signal with the processing device of the commerce server.

4. The computer-implemented method of claim 1 wherein said deriving step is further defined as:
deriving a first value for a gender and a second value for an age associated with the audio signal with the processing device of the commerce server.

5. The computer-implemented method of claim 1 wherein said deriving step is further defined as:
deriving a value for a height associated with the video signal with the processing device of the commerce server.

6. The computer-implemented method of claim 1 wherein said receiving step is further defined as:
receiving, at the processing device of the commerce server, both a video signal and an audio signal from the head mountable unit.

7. The computer-implemented method of claim 1 wherein said receiving step is further defined as receiving, at the processing device of the commerce server, a video signal and an orientation signal from the head mountable unit; and
said deriving step is further defined as deriving a value for a height associated with the video signal and the orientation signal with the processing device of the commerce server.

8. The computer-implemented method of claim 1 wherein said transmitting step is further defined as:
transmitting the advertisement as an audio file to the head mountable unit with the processing device of the commerce server.

9. The computer-implemented method of claim 1 wherein said transmitting step is further defined as:
transmitting the advertisement as an image file to the head mountable unit with the processing device of the commerce server.

10. The computer-implemented method of claim 1 further comprising the step of:
providing the head mountable unit to a consumer prior to said receiving step.

11. The computer-implemented method of claim 1 wherein said obtaining step is further defined as:
obtaining the advertisement from a database of a plurality of advertisements with the processing device of the commerce server.

12. A commerce server comprising:
a database containing a plurality of advertisement files, each of the plurality of advertisement files associated with at least one of an age and a gender;
a processing device having:
an estimation module operable to receive at least one of a video signal and an audio signal and derive a value for at least one of a gender and an age and a height in response to the at least one of the video signal and the audio signal;
a selection module operable to receive the value from the estimation module and select one of the plurality of advertisement files in the database in response to the value; and
a transmission module operable to electronically transmit the selected advertisement file away from the commerce server.

13. The commerce server of claim 12 wherein at least one of said advertisement files includes audio data.

14. The commerce server of claim 12 wherein at least one of said advertisement files includes image data.

15. The commerce server of claim 12 wherein at least one of said advertisement files includes both audio data and image data.

16. The commerce server of claim 12 wherein said processing device further comprises:
a query module operable to transmit signals soliciting the at least one of a video signal and an audio signal.

17. A computer-implemented method comprising:
communicating at least one of audio data and video data to a commerce server with a head mountable device; and
receiving an advertisement with the head mountable device in response to said communicating step.

18. The computer-implemented method of claim 17 further comprising the step of:
receiving a message with the head mountable unit prior to said communicating step.

19. The computer-implemented method of claim 17 wherein said communicating step includes the step of:
completing a tutorial with the head mountable unit prior to said receiving step.
